(19) United States
(12) Patent Application Publication
(10) Pub. No.: US 2019/0086273 A1
(43) Pub. Date: Mar. 21, 2019

(54) METHOD FOR REALIZING LIFESPAN EXTENSION OF THERMOCOUPLE WIRE AGAINST BREAKAGE

(71) Applicant: Okazaki Manufacturing Company, Hyogo (JP)

(72) Inventor: Masaru Yamana, Hyogo (JP)

(21) Appl. No.: 16/193,022

(22) Filed: Nov. 16, 2018

(51) Int. Cl. G01K 7/06; G01K 7/02

(52) U.S. Cl. CPC G01K 7/06; G01K 7/026

(57) ABSTRACT

Instead of a single-element sheathed thermocouple, a sheathed thermocouple is used in which: two pairs of thermocouple wires are enclosed in a metal sheath while being embedded in an inorganic insulating material powder, the thermocouple wires being made of the same materials as and having a diameter that is 90% or greater of or substantially equal to the diameter of thermocouple wires of the single-element sheathed thermocouple, and the metal sheath being made of the same material and having the same outer diameter and wall thickness as a metal sheath of the single-element sheathed thermocouple; only one pair of the two pairs of thermocouple wires are joined to each other at leading ends to form a measuring junction; and a base end of the metal sheath is sealed with a seal with the pair of thermocouple wires joined to each other at the leading ends passing therethrough.

### BACKGROUND OF THE INVENTION

### Field of the Invention

The present invention relates to a method for realizing a sheathed thermocouple in which thermocouple wires are unlikely to break even when a large amount of stress is repeatedly applied, and a wire-breakage-prevention sheathed thermocouple for use in the method.

### Description of the Related Art

As shown in FIG. 6 of JP 2010-230505A or the like, a sheathed thermocouple is a temperature sensor in which a pair of thermocouple wires joined to each other at leading ends to form a measuring junction are enclosed in a metal sheath while being embedded in an inorganic insulating material powder. In order to prevent deterioration of the insulation of the inorganic insulating material due to the intrusion of moisture, a leading end of the metal sheath is welded and sealed, and a base end of the metal sheath is hermetically closed with a resin or the like. Note that the pair of thermocouple wires are a plus thermocouple wire and a minus thermocouple wire that are paired together.

There also are sheathed thermocouples in which, instead of a pair of thermocouple wires, plural pairs of thermocouple wires are enclosed. In practice, sheathed thermocouples in which a pair of thermocouple wires is enclosed are most often used, followed by those in which two pairs of thermocouple wires are enclosed, and sheathed thermocouples in which three or more pairs of thermocouple wires are enclosed are rarely used. A sheathed thermocouple in which a pair of thermocouple wires is enclosed, a sheathed thermocouple in which two pairs of thermocouple wires are enclosed, and a sheathed thermocouple in which three pairs of thermocouple wires are enclosed are generally called a “single-element sheathed thermocouple”, a “double-element sheathed thermocouple”, and a “triple-element sheathed thermocouple”, respectively, and these names are used in the following description.

FIGS. 2A and 2B show a specific structure of a single-element sheathed thermocouple 2; FIG. 2A is a cross-sectional view, taken along the radial direction, of the single-element sheathed thermocouple 2, excluding the leading end portion and base end portion thereof, and FIG. 2B is a cross-sectional view taken along line C-C in FIG. 2A. A pair of thermocouple wires 28 are joined to each other at leading ends to form a measuring junction 29, and are enclosed in a metal sheath 27 while being embedded in an inorganic insulating material powder 210. A leading end 211 of the metal sheath is sealed through welding, and a base end of the metal sheath is sealed with a seal 212 made of resin or the like in a state in which the pair of thermocouple wires 28 pass therethrough.

FIG. 2C shows a cross-sectional view, taken along the longitudinal direction, of an MI (Mineral-Insulated) cable 3 from which the single-element sheathed thermocouple 2 is formed, and the MI cable 3 has the same radial cross section as that shown in FIG. 2A. In the MI cable 3, the pair of thermocouple wires 28 are enclosed in the metal sheath 27 while being embedded in the inorganic insulating material powder 210. The single-element sheathed thermocouple 2 shown in FIGS. 2A and 2B is formed by processing a leading end portion and a base end portion of this MI cable 3.

FIGS. 3A and 3B show a double-element sheathed thermocouple 4. FIG. 3A is a cross-sectional view, taken along the radial direction, of the double-element sheathed thermocouple 4, excluding the leading end portion and base end portion thereof, and FIG. 3B shows a D-D cross section and an E-E cross section of the double-element sheathed thermocouple 4 shown in FIG. 3A. The D-D cross section and the E-E cross section are identical. Two pairs of thermocouple wires 48, in each pair of which the thermocouple wires 48 are joined to each other at leading ends to form a measuring junction 49, are enclosed in a metal sheath 47 while being embedded in an inorganic insulating material powder 410. As is the case with the single-element sheathed thermocouple 2, a leading end 411 of the metal sheath is sealed through welding, and a base end of the metal sheath is sealed with a seal 412 made of resin or the like in a state in which the two pairs of thermocouple wires 48 pass therethrough. An MI cable from which the double-element sheathed thermocouple 4 is formed is the same as the MI cable 3 except that it has a radial cross-sectional shape shown in FIG. 3A, and two pairs of thermocouple wires are enclosed. The double-element sheathed thermocouple 4 shown in FIGS. 3A and 3B is formed by processing a leading end portion and a base end portion of this MI cable.

A sheathed thermocouple with breakage-preventing wires invented by the inventor of the present application and disclosed in JP 2009-75003A addresses such breakage of thermocouple wires. FIGS. 4A to 4C show a sheathed thermocouple 6 with breakage-preventing wires described above; FIG. 4A is a cross-sectional view, taken along the radial direction, of the sheathed thermocouple with breakage-preventing wires, excluding the leading end portion and base end portion thereof, FIG. 4B is a cross-sectional view taken along line F-F in FIG. 4A, and FIG. 4C is a cross-sectional view taken along line G-G in FIG. 4A. A pair of thermocouple wires 68 are joined to each other at leading ends to form a measuring junction 69, and are enclosed in a metal sheath 67 while being embedded in an inorganic insulating material powder 610. Moreover, a pair of breakage-preventing wires 13 that have a smaller linear expansion coefficient than the thermocouple wires 68 and that are made of a highly breakage-resistant material are also enclosed in the metal sheath 67 while being embedded in the inorganic insulating material powder 610.

In the case where the linear expansion coefficients of the thermocouple wires 68 are smaller than the linear expansion coefficient of the metal sheath 67, and the breakage-preventing wires 13 are not provided, that is, in the case of the single-element sheathed thermocouple 2 in FIG. 2, the force with which the metal sheath 27, when heated, extends in the longitudinal direction due to thermal expansion applies tensile stress to the thermocouple wires 28, which have the smaller linear expansion coefficients, via a frictional force between the metal sheath 27 and the inorganic insulating material powder 210 and a frictional force between the inorganic insulating material powder 210 and the thermocouple wires 28. Since the cross-sectional area of the thermocouple wires 28 is small compared with the cross-sectional area of the metal sheath 27, a large amount of tensile stress is generated in the thermocouple wires 28, and if such a large amount of tensile stress is repeatedly generated, the thermocouple wires 28 may break due to cyclic fatigue.

Also, even if the linear expansion coefficients of the thermocouple wires 28 are not smaller than the linear expansion coefficient of the metal sheath 27, if heated extremely rapidly, only the temperature of the metal sheath 27 transiently increases, causing elongation of the metal sheath 27, and tensile stress is generated in the thermocouple wires 28 if only for a short period of time, and if such tensile stress is repeatedly generated, the thermocouple wires 28 may also break.

In the case where the breakage-preventing wires 13 are provided as shown in FIGS. 4A to 4C, the force with which the metal sheath 67 extends when heated is applied mainly to the breakage-preventing wires 13, which have the smaller linear expansion coefficient, via the inorganic insulating material powder 610, and the tensile stress that is generated in the thermocouple wires 68 is reduced, and the thermocouple wires 68 are less likely to break. Also, since the breakage-preventing wires 13 are made of a thick and highly breakage-resistant material, even when tensile stress is repeatedly applied, the breakage-preventing wires 13 themselves are also unlikely to break.

Note that the sheathed thermocouple 6 with breakage-preventing wires shown in FIGS. 4A and 4B is the same as the sheathed thermocouples 2 and 4 shown in FIGS. 2A to 2C and FIGS. 3A and 3B in that the sheathed thermocouple 6 with breakage-preventing wires is formed from an MI cable that has a radial cross-sectional shape shown in FIG. 4A, and is formed by processing a leading end portion and a base end portion of this MI cable.

As described above, breakage of the thermocouple wires of a single-element sheathed thermocouple due to heating and cooling cycles can be avoided by adopting the sheathed thermocouple with breakage-preventing wires disclosed in JP 2009-75003A; however, the MI cable from which this sheathed thermocouple is formed is a special MI cable in which the breakage-preventing wires are enclosed, and is produced exclusively for a sheathed thermocouple with breakage-preventing wires, and thus there is a problem in that the production of the MI cable requires time and is costly.

Therefore, it is an object of the present invention to alleviate this problem.

### SUMMARY OF THE INVENTION

Lifespan extension of a thermocouple wire against breakage is realized by a method, which serves as a measure against breakage of a thermocouple wire of a single-element sheathed thermocouple in which a pair of thermocouple wires that have substantially the same diameter and that are joined to each other at leading ends to form a measuring junction are enclosed in a metal sheath while being embedded in an inorganic insulating material powder, and a base end of the metal sheath is sealed in a state in which the thermocouple wires pass therethrough, the breakage occurring when the single-element sheathed thermocouple is used in an environment subjected to repeated heating and cooling, the method including:

using, instead of the single-element sheathed thermocouple, a sheathed thermocouple in which:
two pairs of thermocouple wires are enclosed in a metal sheath while being embedded in an inorganic insulating material powder, the two pairs of thermocouple wires being made of the same materials as the pair of thermocouple wires of the single-element sheathed thermocouple and having a diameter that is 90% or greater of or substantially equal to that of the pair of thermocouple wires of the single-element sheathed thermocouple, and the metal sheath being made of the same material and having the same outer diameter and wall thickness as the metal sheath of the single-element sheathed thermocouple;
one pair of thermocouple wires, of the two pairs of thermocouple wires, are joined to each other at leading ends to form a measuring junction; and
a base end of the metal sheath is sealed in a state in which the pair of thermocouple wires that are joined to each other at the leading ends pass therethrough; and

performing temperature measurement using the pair of thermocouple wires that are joined to each other at the leading ends.

Tensile stress that may lead to breakage of a thermocouple wire is generated when the thermal elongation amount of a metal sheath becomes greater than the thermal elongation amount of a thermocouple wire. “Thermal elongation amount” is the product of a linear expansion coefficient and temperature, and therefore, if a metal that has a greater linear expansion coefficient than the linear expansion coefficient of a thermocouple wire is used for the metal sheath, tensile stress will be generated in the thermocouple wire under almost all heating conditions. Moreover, even if the linear expansion coefficient of the metal sheath is not greater than that of a thermocouple wire, in a transient state in which only the temperature of the metal sheath is increased due to extremely rapid heating, the thermal elongation amount of the metal sheath exceeds that of a thermocouple wire, and thus tensile stress is generated in the thermocouple wire. Therefore, in the case where a metal that has a greater linear expansion coefficient than the linear expansion coefficient of a thermocouple wire is used for a metal sheath, tensile stress will be repeatedly generated in the thermocouple wire in an environment subjected to repeated heating and cooling, and even in the case where the linear expansion coefficient of a metal sheath is not greater than that of a thermocouple wire, tensile stress will be repeatedly generated in the thermocouple wire in an environment subjected to repeated extremely rapid heating.

Based on physical laws, stress that is generated in the thermocouple wire due to a change in temperature depends on the cross-sectional area, the Young's modulus, and the product of the linear expansion coefficient and the temperature, of each of the metal sheath and the thermocouple wire. In the same temperature environment, when a comparison is made between a case where a single-element sheathed thermocouple is used and a case where a wire-breakage-prevention sheathed thermocouple is used, only the cross-sectional area of the thermocouple wires, of the above-described factors, is different.

Hereinafter, a sheathed thermocouple of the present invention that is used instead of a single-element sheathed thermocouple in order to extend the lifespan of the thermocouple wires against breakage is referred to as “wire-breakage-prevention sheathed thermocouple”. Stress that is generated in thermocouple wires of a wire-breakage-prevention sheathed thermocouple is evaluated as follows. Since the diameter of the thermocouple wires of the wire-breakage-prevention sheathed thermocouple is 90% or greater of that of the single-element sheathed thermocouple, the cross-sectional area of the thermocouple wires of the wire-breakage-prevention sheathed thermocouple is at least 0.81 times, per single thermocouple wire, that of the single-element sheathed thermocouple, and is 1.62 or more times, overall, that of the single-element sheathed thermocouple because the number of thermocouple wires of the wire-breakage-prevention sheathed thermocouple is twice that of the single-element sheathed thermocouple. Since stress is substantially proportional to the inverse of a cross-sectional area, tensile stress that is generated in the two pairs of thermocouple wires of the wire-breakage-prevention sheathed thermocouple is at most about 62% of the stress that is generated in the pair of thermocouple wires of the single-element sheathed thermocouple.

Next, the number of cycles in which tensile stress can be applied until a metal breaks is generally evaluated using an S-N curve (Stress-Number of cycles to failure curve). It is known that an S-N curve for a metal, in which the number of cycles in which tensile stress can be applied until the metal breaks is plotted on a logarithmic scale on the horizontal axis, and the magnitude of stress is plotted on a linear scale on the vertical axis, is a substantially straight line that slopes down from left to right within a stress range in which breakage occurs. A straight-line plot with a logarithmic scale on the horizontal axis indicates that a small reduction in tensile stress that is generated in a thermocouple wire, which is made of a metal, results in a significant increase in the number of cycles in which tensile stress can be applied until the thermocouple wire breaks.

As described above, with the method of the present invention, that is, the replacement of the single-element sheathed thermocouple with the wire-breakage-prevention sheathed thermocouple, the tensile stress that is generated in thermocouple wires is reduced at most to about 62%, so that the number of cycles of heating and cooling until the thermocouple wires break is significantly increased, and lifespan extension can be achieved accordingly.

The convenience and the economic advantages achieved by this method also constitute grounds for the invention.

First, since a replaced single-element sheathed thermocouple and the wire-breakage-prevention sheathed thermocouple have the same outer diameter, this method is convenient in that it is unnecessary to change the shape of a mount portion. For example, a sheathed thermocouple is often used inserted in a hole provided in a portion to be measured, and the insertion hole for the single-element sheathed thermocouple can be used as-is as the insertion hole for the wire-breakage-prevention sheathed thermocouple without having to be reformed.

Next, the wire-breakage-prevention sheathed thermocouple structurally differs from a double-element sheathed thermocouple only in that, in the double-element sheathed thermocouple, thermocouple wires in each pair of the two pairs of thermocouple wires are joined to each other at leading ends to form a measuring junction, whereas, in the wire-breakage-prevention sheathed thermocouple, only one pair of thermocouple wires of the two pairs of thermocouple wires are joined to each other at leading ends to form a measuring junction, and only the pair of thermocouple wires that are joined to each other at the leading ends pass through the seal at the end of the metal sheath. The temperature measurement is performed using this pair of thermocouple wires that are joined to each other at the leading ends.

This means that the wire-breakage-prevention sheathed thermocouple is formed from the same MI cable as that of the double-element sheathed thermocouple, but with regard to the processing of both end portions of the MI cable, processing for joining the leading ends of a pair of thermocouple wires is omitted from the processing of the leading end portion, and processing for making base ends of that pair of thermocouple wires pass through the seal is omitted from the processing of the base end portion. In this manner, this method is economically advantageous in that an existing method for producing a commonly commercially-available double-element sheathed thermocouple can be applied to the production of the wire-breakage-prevention sheathed thermocouple merely by omitting some processing steps therefrom, and it is unnecessary to newly establish a special production method.

Furthermore, as can be understood from a comparison between the radial cross section of the single-element sheathed thermocouple 2 shown in FIG. 2A and the radial cross section of the double-element sheathed thermocouple 4 shown in FIG. 3A, in a double-element sheathed thermocouple, a pair of thermocouple wires that are added to a single-element sheathed thermocouple are each provided in a free space located at a position that is rotated by 90 degrees in the circumferential direction from the C-C cross section line in FIG. 2A. Thus, it is unnecessary to significantly reduce the diameter of the thermocouple wires, and normally, a commercially available double-element sheathed thermocouple has a thermocouple wire diameter that is 90% or greater of the thermocouple wire diameter of a commercially available single-element sheathed thermocouple. Also, normally, the metal sheath of a commercially available single-element sheathed thermocouple and the metal sheath of a commercially available double-element sheathed thermocouple have the same wall thickness, as long as the metal sheaths have the same outer diameter. Therefore, it is unnecessary to prepare a special MI cable from which the wire-breakage-prevention sheathed thermocouple is to be formed, and the same MI cable as that from which a commonly commercially-available double-element sheathed thermocouple is formed can be used to form the wire-breakage-prevention sheathed thermocouple.

In this manner, with a wire-breakage-prevention sheathed thermocouple in which two pairs of thermocouple wires are enclosed in a metal sheath while being embedded in an inorganic insulating material powder, one pair of thermocouple wires, of the two pairs of thermocouple wires, are joined to each other at leading ends to form a measuring junction, and a base end of the metal sheath is sealed in a state in which the pair of thermocouple wires that are joined to each other at the leading ends pass therethrough, the above-described method for extending the lifespan of a thermocouple wire against breakage can be effectively applied.

As described above, the wire-breakage-prevention sheathed thermocouple of the method of the present invention has an advantage in that it can be produced merely by performing an ordinary method for producing a double-element sheathed thermocouple excluding some steps. However, in the case where it is difficult to exclude those steps for the reason that the production process is automated, for example, or in the case where the exclusion of those steps actually increases the production costs, those steps need not be excluded, and the wire-breakage-prevention sheathed thermocouple may also be configured such that, not only one pair of thermocouple wires, of the two pairs of thermocouple wires, are joined to each other at leading ends to form a measuring junction, but also the other pair of thermocouple wires are joined to each other at leading ends to form a measuring junction, and the base end of the metal sheath is sealed in a state in which not only one pair of thermocouple wires but also the other pair of thermocouple wires pass therethrough. This sheathed thermocouple is a double-element sheathed thermocouple itself, and thus, the double-element sheathed thermocouple constitutes the wire-breakage-prevention sheathed thermocouple of the present invention as-is. The temperature measurement is performed using either pair of thermocouple wires of the two pairs of thermocouple wires.

When, as a measure against breakage of a thermocouple wire enclosed in a single-element sheathed thermocouple when used in an environment subjected to repeated heating and cooling, the method of the present invention is adopted in which the single-element sheathed thermocouple is replaced with the wire-breakage-prevention sheathed thermocouple that can be easily produced without requiring any special constituent component or any special production method and that does not require modification of a mount portion of an object to be measured, an effect of extending the lifespan of the thermocouple wires until breakage can be economically advantageously achieved.

### BRIEF DESCRIPTION OF THE DRAWINGS

FIG. 1A is a cross-sectional view, taken along the radial direction, of a wire-breakage-prevention sheathed thermocouple, excluding a leading end portion and base end portion thereof.

FIG. 1B is a cross-sectional view taken along line A-Ain FIG. 1A.

FIG. 1C is a cross-sectional view taken along line B-B in FIG. 1A

FIG. 2A is a cross-sectional view, taken along the radial direction, of a single-element sheathed thermocouple, excluding a leading end portion and base end portion thereof.

FIG. 2B is a cross-sectional view taken along line C-C in FIG. 2A

FIG. 2C is a cross-sectional view, taken along the longitudinal direction, of an MI cable from which the single-element sheathed thermocouple is formed.

FIG. 3A is a cross-sectional view, taken along the radial direction, of a double-element sheathed thermocouple, excluding a leading end portion and base end portion thereof.

FIG. 3B shows a D-D cross section and an E-E cross section of the double-element sheathed thermocouple in FIG. 3A

FIG. 3C is a cross-sectional view, taken along the radial direction, of a triple-element sheathed thermocouple, excluding a leading end portion and base end portion thereof.

FIG. 4A is a cross-sectional view, taken along the radial direction, of a sheathed thermocouple with breakage-preventing wires, excluding a leading end portion and base end portion thereof.

FIG. 4B is a cross-sectional view taken along line F-F in FIG. 4A.

FIG. 4C is a cross-sectional view taken along line G-G in FIG. 4A.

### DESCRIPTION OF THE EMBODIMENTS

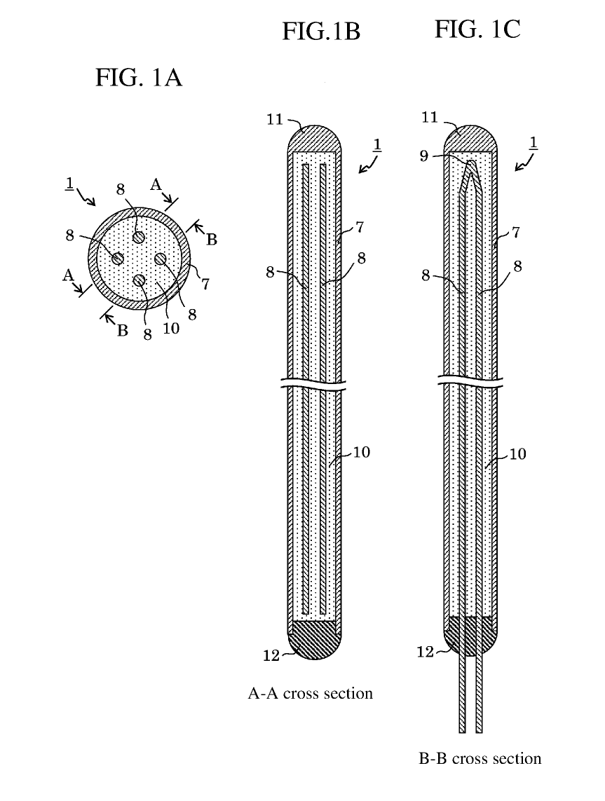

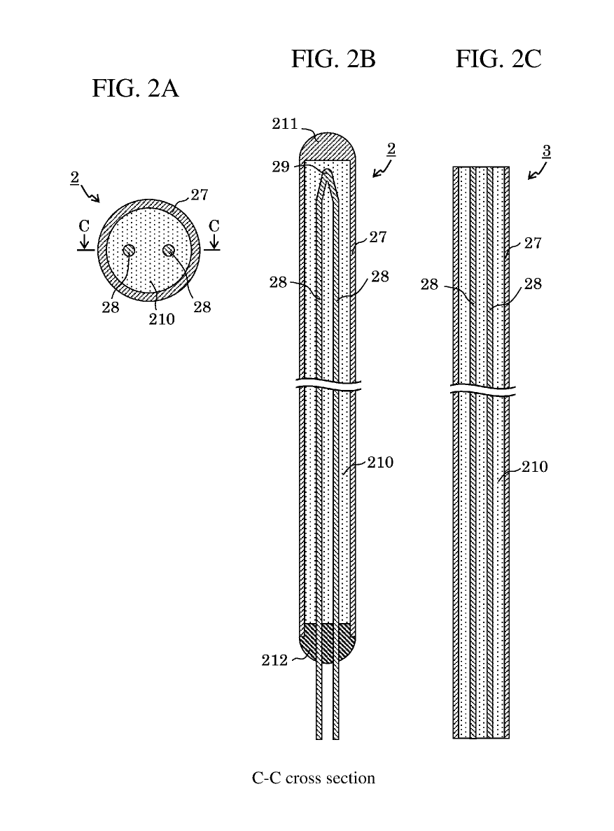

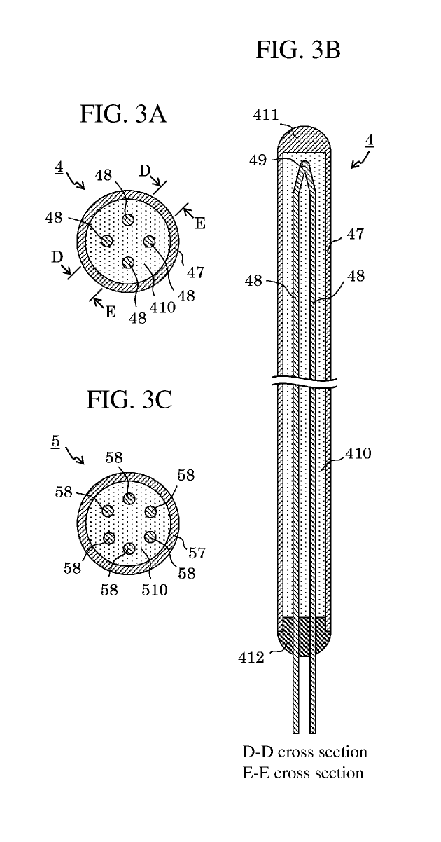

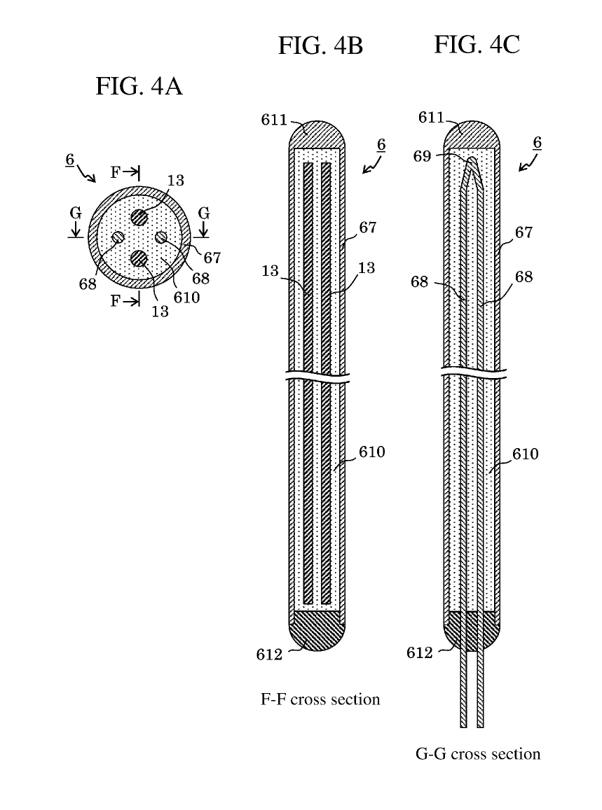

An embodiment of the present invention will be described with reference to FIGS. 1A to 1C, and also with reference to the above-described FIGS. 2A to 2C and 3A to 3C, as appropriate. FIG. 1A is a cross-sectional view, taken along the radial direction, of a wire-breakage-prevention sheathed thermocouple embodying the present invention, excluding the leading end portion and base end portion thereof, FIG. 1B is a cross-sectional view taken along line A-Ain FIG. 1A, and FIG. 1C is a cross-sectional view taken along line B-B in FIG. 1A.

If a single-element sheathed thermocouple 2 shown in FIGS. 2A and 2B, in which a pair of thermocouple wires 28 that have substantially the same diameter and that are joined to each other at leading ends to form a measuring junction 29 are enclosed in a metal sheath 27 while being embedded in an inorganic insulating material powder 210, and a base end of the metal sheath 27 is sealed in a state in which the thermocouple wires 28 pass therethrough, is used in an environment subjected to repeated heating and cooling, the enclosed thermocouple wires 28 may break.

As a measure against this breakage, instead of the single-element sheathed thermocouple 2, a wire-breakage-prevention sheathed thermocouple 1 shown in FIGS. 1A to 1C is used in which two pairs of thermocouple wires 8 are enclosed in a metal sheath 7 while being embedded in an inorganic insulating material powder 10, the thermocouple wires 8 being made of the same materials as the thermocouple wires 28 of the single-element sheathed thermocouple 2 shown in FIGS. 2A to 2C, and having a diameter that is 90% or greater of the diameter of the thermocouple wires 28, and the metal sheath 7 being made of the same material and having substantially the same outer diameter and wall thickness as the metal sheath 27 of the single-element sheathed thermocouple 2 in FIGS. 2A to 2C, only one pair of thermocouple wires 8 of the two pairs of thermocouple wires 8 are joined to each other at leading ends to form a measuring junction 9, and a base end of the metal sheath 7 is sealed with a seal 12 in a state in which the pair of thermocouple wires 8 that are joined to each other at the leading ends pass therethrough. Thus, the thermocouple wire lifespan until breakage occurs is extended.

As described above, if a metal that has a greater linear expansion coefficient than the linear expansion coefficients of the thermocouple wires is used for the metal sheath, tensile stress is repeatedly generated in the thermocouple wires in an environment subjected to repeated heating and cooling, causing breakage of the thermocouple wires, and even if the linear expansion coefficient of the metal sheath is not greater than those of the thermocouple wires, tensile stress is repeatedly generated in the thermocouple wires in an environment subjected to repeated extremely rapid heating, causing breakage of the thermocouple wires.

Moreover, as described above, the tensile stress that is generated in the thermocouple wires 8 of the wire-breakage-prevention sheathed thermocouple 1 is reduced at most to approximately 62% of the replaced single-element sheathed thermocouple 2, and the number of cycles of heating and cooling until the thermocouple wires 8 break is significantly increased, and lifespan extension can be achieved accordingly.

Next, the wire-breakage-prevention sheathed thermocouple 1 in FIGS. 1A to 1C structurally differs from a double-element sheathed thermocouple 4 shown in FIGS. 3A and 3B in that, in the double-element sheathed thermocouple 4, each pair of thermocouple wires 48 of the two pairs of thermocouple wires 48 are joined to each other at leading ends to form a measuring junction 49, and an end of a metal sheath 47 is sealed with a seal 412 in a state in which the two pairs of thermocouple wires 48 pass therethrough, whereas, in the wire-breakage-prevention sheathed thermocouple 1, only one pair of thermocouple wires 8 of the two pairs of thermocouple wires 8 are joined to each other at the leading ends to form the measuring junction 9, and only the pair of thermocouple wires 8 that are joined to each other at the leading ends pass through the seal 12 at the end of the metal sheath 7. In the wire-breakage-prevention sheathed thermocouple 1, the temperature measurement is performed using this pair of thermocouple wires 8 that are joined to each other at the leading ends.

In this embodiment, the outer diameters of the metal sheath 27 of the single-element sheathed thermocouple 2 and the metal sheath 7 of the wire-breakage-prevention sheathed thermocouple 1 are specifically set to be the following three different values: 4.8 mm, 6.4 mm, and 8.0 mm. With respect to the cross-sectional dimensions of a single-element sheathed thermocouple and a double-element sheathed thermocouple that are commercially available, examples regarding those from two companies A and B are shown in Table 1 below.

TABLE 1

| | Single-element sheathed thermocouple | | | Double-element sheathed thermocouple | | |
|---|---|---|---|---|---|---|
| | Metal sheath | Metal sheath | Thermocouple | Metal sheath | Metal sheath | Thermocouple |
| | Outer diameter | Wall thickness | wires Diameter | Outer diameter | Wall thickness | wires Diameter |
| Company A | 4.8 mm | 0.53 mm | 0.79 mm | 4.8 mm | 0.53 mm | 0.74 mm |
| | 6.4 mm | 0.74 mm | 1.04 mm | 6.4 mm | 0.74 mm | 0.97 mm |
| | 8.0 mm | 0.91 mm | 1.30 mm | 8.0 mm | 0.91 mm | 1.22 mm |
| Company B | 4.8 mm | 0.72 mm | 0.76 mm | 4.8 mm | 0.72 mm | 0.76 mm |
| | 6.4 mm | 0.93 mm | 1.00 mm | 6.4 mm | 0.93 mm | 1.00 mm |
| | 8.0 mm | 1.16 mm | 1.30 mm | 8.0 mm | 1.16 mm | 1.30 mm |

To give examples of the materials, the thermocouple wires 8 may be K-type thermocouple wires, the metal sheath 7 may be made of SUS 316, and the inorganic insulating material powder 10 may be magnesia. The materials are, of course, not limited to these materials.

As shown in Table 1, when the metal sheaths have the same outer diameter, the wall thickness of the metal sheath of the single-element sheathed thermocouple and the wall thickness of the metal sheath of the double-element sheathed thermocouple are the same, with respect to both of the companies A and B, and the diameter of the thermocouple wires of the double-element sheathed thermocouple from the company A is 90% or greater of that of the single-element sheathed thermocouple from that company, while the diameter of the thermocouple wires of the double-element sheathed thermocouple from the company B is the same as that of the single-element sheathed thermocouple from that company.

This means that, at the production stage of the wire-breakage-prevention sheathed thermocouple 1 of this embodiment, the same MI cable as the MI cable from which a commercially available double-element sheathed thermocouple is formed can be used to form the wire-breakage-prevention sheathed thermocouple 1, and the wire-breakage-prevention sheathed thermocouple 1 can be produced by performing a process for processing a commercially available double-element sheathed thermocouple, excluding the step of joining a pair of thermocouple wires to each other at the leading ends, in the processing of the leading end portion, and the step of making that pair of thermocouple wires pass through the seal at the base end, in the processing of the base end portion. In this manner, this embodiment is economically advantageous in that an existing method for producing a commonly commercially-available double-element sheathed thermocouple can be applied to the production of the wire-breakage-prevention sheathed thermocouple 1 merely by excluding some of the processing steps.

However, in the case where it is difficult to exclude those steps for the reason that the production process is automated, for example, or in the case where the exclusion of those steps actually increases the production costs, those steps need not be excluded, and a wire-breakage-prevention sheathed thermocouple in which each pair of thermocouple wires of the two pairs of thermocouple wires are joined to each other at the leading ends, and both of the two pairs of thermocouple wires pass through the seal at the base end may be produced. In this case, the shape of the wire-breakage-prevention sheathed thermocouple 1 is exactly the same as that of a double-element sheathed thermocouple, and thus, a double-element sheathed thermocouple can be applied to the wire-breakage-prevention sheathed thermocouple of the present invention as-is. The temperature measurement is performed using either pair of the two pairs of thermocouple wires.

In addition to the above-described economic advantages, this embodiment is convenient in that, since the wire-breakage-prevention sheathed thermocouple 1 has the same outer diameter as the replaced single-element sheathed thermocouple, it is unnecessary to change the shape of a mount portion.

Note that, as described above, in a double-element sheathed thermocouple, a pair of thermocouple wires that are added to a single-element sheathed thermocouple are disposed in free spaces of the single-element sheathed thermocouple. Thus, as shown in Table 1, there is no significant difference in the diameter of the thermocouple wires between a commercially available single-element sheathed thermocouple and a commercially available double-element sheathed thermocouple. However, with regard to a triple-element sheathed thermocouple, since no free space in which a pair of thermocouple wires can be added is left in a double-element sheathed thermocouple, as can be understood from a comparison between FIGS. 3A and 3C, three pairs of thermocouple wires with a reduced diameter are equidistantly arranged in a commercially available triple-element sheathed thermocouple.

Even if the wire-breakage-prevention sheathed thermocouple has three pairs of thermocouple wires, the wire-breakage preventing effect is small, because the diameter of the thermocouple wires is reduced if the MI cable and the production method of a commercially available triple-element sheathed thermocouple are applied. In addition, generally, a triple-element sheathed thermocouple is rarely used, and therefore, does not offer benefits in terms of mass production and is expensive. Thus, a wire-breakage-prevention sheathed thermocouple having three pairs of thermocouple wires is inferior to a wire-breakage-prevention sheathed thermocouple having two pairs of thermocouple wires in terms of economic effects.

If a single-element sheathed thermocouple is used to monitor the temperature of a device, such as a reciprocating engine or a turbine engine, in which a change in temperature is repeatedly caused by the device starting and stopping, a problem may arise in that the thermocouple wires will break. In that case, the present invention exhibits its effects to address this problem. As an actual example, there was an instance in which the thermocouple wires of a single-element sheathed thermocouple that was attached to monitor the temperature of a reciprocating engine for testing frequently broke, but breakage ceased to occur as a result of applying the present invention.

What is claimed is:

1. A method for realizing lifespan extension of a thermocouple wire against breakage, as a measure against breakage of a thermocouple wire of a single-element sheathed thermocouple in which a pair of thermocouple wires that have substantially the same diameter and that are joined to each other at leading ends to form a measuring junction are enclosed in a metal sheath while being embedded in an inorganic insulating material powder, and a base end of the metal sheath is sealed in a state in which the thermocouple wires pass therethrough, the breakage occurring when the single-element sheathed thermocouple is used in an environment subjected to repeated heating and cooling, the method comprising:
using, instead of the single-element sheathed thermocouple, a sheathed thermocouple in which:
two pairs of thermocouple wires are enclosed in a metal sheath while being embedded in an inorganic insulating material powder, the two pairs of thermocouple wires being made of the same materials as the pair of thermocouple wires of the single-element sheathed thermocouple and having a diameter that is 90% or greater of or substantially equal to that of the pair of thermocouple wires of the single-element sheathed thermocouple, and the metal sheath being made of the same material and having the same outer diameter and wall thickness as the metal sheath of the single-element sheathed thermocouple;
one pair of thermocouple wires, of the two pairs of thermocouple wires, are joined to each other at leading ends to form a measuring junction; and
a base end of the metal sheath is sealed in a state in which the pair of thermocouple wires that are joined to each other at the leading ends pass therethrough; and
performing temperature measurement using the pair of thermocouple wires that are joined to each other at the leading ends.

2. The method for realizing lifespan extension of a thermocouple wire against breakage according to claim 1,
wherein, in the sheathed thermocouple that is used instead of the single-element sheathed thermocouple in order to extend the lifespan of a thermocouple wire against breakage,
not only one pair of thermocouple wires, of the two pairs of thermocouple wires, are joined to each other at the leading ends to form the measuring junction, but also the other pair of thermocouple wires are joined to each other at leading ends to form a measuring junction, and
the base end of the metal sheath is sealed in a state in which not only the one pair of thermocouple wires but also the other pair of thermocouple wires pass therethrough, and
temperature measurement is performed using either pair of thermocouple wires of the two pairs of thermocouple wires.
